(19) United States
(12) Patent Application Publication
(10) Pub. No.: US 2012/0258548 A1
(43) Pub. Date: Oct. 11, 2012

(54) REDOX SENSOR

(75) Inventors: Wayne Chudyk, Somerville, MA (US); Christine Sotolongo, West Roxbury, MA (US); Eric Mueller, Worcester, MA (US)

(73) Assignee: TUFTS UNIVERSITY, Medford, MA (US)

(21) Appl. No.: 13/440,492

(22) Filed: Apr. 5, 2012

Related U.S. Application Data
(60) Provisional application No. 61/472,428, filed on Apr. 6, 2011.

(51) Int. Cl. G01N 21/59; G01N 21/64; G01N 21/75

(52) U.S. Cl. 436/172; 422/82.05; 436/164; 422/82.08; 422/82.09

(57) ABSTRACT

Provided herein are devices, methods, and uses for measuring redox potential. For example, provided herein are fiber optic redox sensors and methods of use thereof.

This application claims priority to provisional application Ser. No. 61/472,428, filed Apr. 6, 2011, which is herein incorporated by reference in its entirety.

### FIELD OF INVENTION

Provided herein are devices, methods, and uses for measuring redox potential. For example, the present technology relates to fiber optic redox sensors and methods of use thereof.

### BACKGROUND

Oxidation-reduction (redox) potential is an important parameter of interest in many environmental applications. In particular, measurements of redox potential are useful in describing, predicting, and modeling contamination and remediation processes. Though useful, changes in redox potential during treatment and remediation are often unknown. Quantifying product formation is currently the conventional means of estimating reaction conditions and possible reaction pathways. In addition, environmental measurements often involve sampling followed by analysis in an instrument sample cell. However, sampling can introduce measurement errors due to cross-contamination and sample changes. Thus, in-situ methods are preferred over methods requiring sampling before analysis. Accordingly, direct measurements of redox potential are important for accurately examining environmental systems.

Electrode measurements of redox potential are sometimes useful; however, design and size requirements limit their reliable use for some small-scale laboratory studies and for in-situ sampling. Lab-on-a-chip systems are promising for redox analyses, but they typically also involve sampling followed by analysis. Attempts to improve redox measurements have employed a variety of surrogate indicators of redox potential, e.g., consumption rates of terminal electron acceptors or changes in optically active dyes. While such dyes have shown potential, their use has been generally limited to relatively large cuvette or sorbed resin bead systems. Consequently, what is needed is a portable, reliable, and easy-to-use sensor for measuring the redox potential of a sample in situ.

### SUMMARY

Provided herein are devices, methods, and uses for measuring redox potential. For example, provided herein are fiber optic redox sensors and methods of use thereof.

The present technology provides a fiber optic device for monitoring redox potential in a sample. In some embodiments, a redox-sensitive dye is sorbed into a membrane at the end of a fiber optic cable. The sorbed dye has optical properties that are sensitive to, and thus provide an indicator of, its redox environment. The dye's optical properties can be queried, for example, by exposing the dye to an appropriate wavelength of light and measuring the dye's absorbance or fluorescence emission at the same or at a different appropriate wavelength. In some embodiments, a fiber optic cable is used to expose the dye to light and/or to measure the dye's absorbance or fluorescence emission. The resulting measurement can be compared with known values for absorbance and fluorescence to determine the redox potential of a sample.

Accordingly, provided herein is a device for sensing redox potential in a sample comprising an electromagnetic radiation source, a membrane optically coupled to the electromagnetic radiation source, and a dye sorbed to the membrane. In some embodiments, the device further comprises a detector. While the device is not limited in the manner by which components are optically coupled, in some embodiments the device further comprises an excitation fiber and a detection fiber, wherein the excitation fiber optically couples the membrane to the electromagnetic radiation source and the detection fiber optically couples the membrane to the detector.

Furthermore, the technology is not limited in the types of electromagnetic radiation sources that can be used. For example, some embodiments provide that the electromagnetic radiation source is a light emitting diode (LED), a laser, an incandescent lamp, a halogen lamp, a fluorescent lamp, a gas discharge lamp, or an arc lamp. Preferred embodiments use an LED or laser. In particular, some embodiments provide an electromagnetic radiation source that produces light of about 520 nanometers and some embodiments provide an electromagnetic radiation source that produces light of about 598 nanometers.

The technology is not limited in the dye that can be used provided that the dye has the desired characteristics to provide an indication of redox state. In some embodiments, the dye has an observable property that changes with the redox state of the dye. For instance, some specific embodiments provide that the photoactive dye is phenosafranine (i.e., 3,7-diamino-5-phenylphenazinium chloride) and some embodiments provide that the dye is thionine (i.e., 3-(diethylamino)-7-(dimethylamino)phenazathionium chloride). Other suitable dyes include, but are not limited to, nile blue, toluylene blue, and safranin. Any suitably sensitive optical quality of the dye can be used as an indicator of the dye's redox environment. For example, in some embodiments of the technology provided herein, the dye's observable property is absorbance and in some embodiments the dye's observable property is fluorescence emission.

Furthermore, the technology is not limited in the material that can be used for the membrane. Any membrane having suitable chemical, physical, and optical properties can be used. In some embodiments, the membrane is a synthetic polymer with ionic properties. Some exemplary embodiments provide that the membrane is a perfluorosulfonate anionic film. In some embodiments, the membrane is made of a biocompatible material.

The device can be configured in any way that allows monitoring the dye's optical properties as an indication of redox potential. For example, some embodiments provide that the photodetector monitors light intensity at a wavelength that is about the same wavelength as the wavelength produced by the electromagnetic radiation source and some embodiments provide that the photodetector monitors light intensity at a wavelength that is longer than the wavelength produced by the electromagnetic radiation source. For example, some embodiments provide that the photodetector monitors light intensity at a wavelength that is about 100 nm longer than the wavelength produced by the electromagnetic radiation source. The device uses any suitable photodetector to measure the dye's optical properties. For example, in some embodiments the photodetector is a spectrometer. Additional exemplary embodiments provide that the photodetector is a photoresister, a photovoltaic cell, a photodiode, a photomultiplier tube, a photocathode, a phototransister, a charge-coupled device, or a reverse-biased LED. In some embodiments, the photodetector monitors one or more wavelengths and in some embodiments the photodetector records a spectrum.

Provided herein are embodiments of the technology wherein a fiber optic cable transmits light from the electromagnetic radiation source to the membrane and from the membrane to the detector. The fibers of the fiber optic cables can be produced from any suitable material that allows transmission of light along the fiber axis from one end of the fiber to the other end. For example, embodiments provide that the excitation fiber or the detection fiber is made of borosilicate, quartz, UV silica, sapphire, zirconium fluoride, water-free (low-OH) silica, germanium oxide, C1 chalcogenide, C2 chalcogenide, C3 chalcogenide, selenium fiber, plastic, fluorozirconate, fluoroaluminate, or silver halide.

Also provided herein are methods for measuring redox potential with the fiber optic sensor by contacting a sample with an embodiment of the device, obtaining a light intensity reading, and comparing the light intensity reading with an expected value corresponding to high or low redox potential. In some embodiments of the method, the dye's observable property has a high value when the sample has a high redox potential and a low value when the sample has a low redox potential. In other embodiments of the method, the dye's observable property has a low value when the sample has a high redox potential and a high value when the sample has a low redox potential. In some embodiments, the transition between the low and high values occurs at a redox potential of about −244 millivolts. In some embodiments, the transition between the low and high values occurs at a redox potential of about 77 millivolts.

Also provided herein are methods for obtaining redox potential measurements from samples. The device is not limited in the types of samples that can be measured. For example, in some embodiments, the sample is a water sample and the redox potential measurement provides a measure of a water quality of the sample. In some embodiments, the water sample is surface fresh water, ground fresh water, estuarine water, or sea water. In some embodiments, the redox potential measurement provides a measure of contamination and bioremediation, e.g., the redox potential measurement provides a measurement for monitoring zero-valent iron remediation procedures or microbial reduction of chlorinated low molecular weight hydrocarbons.

Other samples for which the device finds use are environmental samples, industrial samples, medical or clinical samples, and the like. For example, in some embodiments provided herein, the sample is a biological sample and the redox potential measurement provides a measure of the redox state of the biological sample. In some embodiments, the sample is a clinical sample and the redox potential measurement provides a measure of the redox state of the clinical sample. For example, some embodiments provide that the clinical sample is a tissue or a cell. In some embodiments, the sample is a research sample and the redox potential measurement provides a measure of the redox state of the research sample. For example, some embodiments provide that the research sample is from a bacterial culture, a eukaryotic cell culture, an archaeal culture, a fermenter, a biofilm, a soil, a plant tissue, a chemical reaction, a bioreactor, a fuel cell, or an electrochemical cell. Some embodiments provide that the research sample is from a model bioremediation column.

Additional embodiments will be apparent to persons skilled in the relevant art based on the teachings contained herein.

### BRIEF DESCRIPTION OF THE DRAWINGS

These and other features, aspects, and advantages of the present technology will become better understood with regard to the following drawings:

FIG. 1 is a plot showing absorbance spectra of phenosafranine at high and low redox potentials.

FIG. 2 is a plot showing that dye absorbance tracks the measured oxidation-reduction potential (ORP) in a sample.

FIG. 3 shows an arrangement of excitation and detection fibers in an exemplary embodiment of the technology.

FIG. 4 shows embodiments of the technology in exemplary bench-scale measurement apparatuses. FIG. 4A shows one exemplary embodiment and FIG. 4B shows an additional exemplary embodiment.

### DETAILED DESCRIPTION

Provided herein are devices, methods, and uses for measuring redox potential. For example, the present technology relates to fiber optic redox sensors and methods of use thereof.

### Definitions

To facilitate an understanding of the present technology, a number of terms and phrases are defined below. Additional definitions are set forth throughout the detailed description.

As used herein, “a” or “an” or “the” can mean one or more than one. For example, “a” widget can mean one widget or a plurality of widgets.

As used herein, “biocompatible” means that a material performs with an appropriate host response in a specific application without causing a toxic or injurious effect on biological systems. In some embodiments, biocompatible refers to the ability of a biomaterial to perform its desired function with respect to a medical therapy without eliciting any undesirable local or systemic effects in the recipient or beneficiary of that therapy, but generating the most appropriate beneficial cellular or tissue response in that specific situation, and optimizing the clinically relevant performance of that therapy.

As used herein, “sorbed” means absorption, adsorption, a combination thereof, or otherwise being incorporated into or onto a solid matrix. In some embodiments, a sorbed substance is associated with a matrix in such a way as not to be readily removed from the matrix unless subjected to conditions that are intentionally or inadvertently performed to remove the sorbed composition from the solid matrix.

As used herein “optically coupled” refers to an arrangement in which light or electromagnetic radiation is directed from one optical component to another in a manner that maintains the integrity of the signal communicated by the light or electromagnetic radiation.

As used herein, “electromagnetic radiation” is used interchangeably with “light” to refer to a form of energy transmission through a vacuum or a medium in which electric and magnetic fields are propagated as waves. Further, it includes visible light, infrared, and ultraviolet. The electromagnetic radiation may comprise a single wavelength or a number of wavelengths. The wavelength or wavelengths may be within the visible spectrum, outside the visible spectrum (e.g., in the infrared or ultraviolet), or a combination thereof. While “light” is electromagnetic radiation of a wavelength that is visible to the human eye (in a range from about 380 or 400 nanometers to about 760 or 780 nanometers), the term “light” is used herein to mean electromagnetic radiation of any wavelength, whether visible or not.

As used herein, “source” refers to a process by which energy enters a system. For example, in fiber optic applications, a source usually refers to the radiation source, e.g., a laser. The source may produce broadband or one or more distinct wavelengths. Further, the source may output energy in single or multiple shots or impulses of energy or may scan through a series or continuum of wavelengths.

As used herein, the term “sample” is used in its broadest sense. In one sense it can refer to animal cells or tissues. In another sense, it is meant to include a specimen or culture obtained from any source, such as biological and environmental samples. Biological samples may be obtained from plants or animals (including humans) and encompass fluids, solids, tissues, and gases. Environmental samples include environmental material such as surface matter, soil, water, and industrial samples. A sample may be removed from its natural milieu or environment or a sample may be tested without removing it from its natural milieu or environment (e.g., in-situ sampling). These examples are not to be construed as limiting the sample types applicable to the present invention.

As used herein, the term “subject” refers to organisms to be subjected to various tests or measurements provided by the technology. The term “subject” includes animals, preferably mammals, including humans. In a preferred embodiment, the subject is a primate. In an even more preferred embodiment, the subject is a human.

As used herein, the term “in vivo” refers to the natural environment (e.g., an animal or a cell) and to processes or reactions that occur within a natural environment.

As used herein, the term “in situ” refers to the sample or other object of measurement being present in, and not having been removed from, its natural milieu or environment.

As used herein, “wavelength” refers to the distance between the tops of two successive crests of an electromagnetic wave. Substances react with energy at different wavelengths in different ways. The properties of a substance (e.g., absorbance, emission, reflection, fluorescence, etc.) depend on the wavelength of energy with which it is interacting.

As used herein, “absorbance” refers to the attenuation of electromagnetic radiation. Absorbance is the logarithm of the ratio of incident to transmitted radiant power through a sample. Absorbance thus has a logarithmic relationship to transmittance (l₀/I) such that A_{λ}=log(I₀/I), where I is the intensity of light at a specified wavelength λ that has passed through a sample (i.e., transmitted light intensity) and I₀ is the intensity of the light before it enters the sample (i.e., incident light intensity). Absorbance is often also called “optical density”.

### Embodiments of the Technology

Although the disclosure herein refers to certain illustrated embodiments, it is to be understood that these embodiments are presented by way of example and not by way of limitation.

The present technology provides a fiber optic device for monitoring redox potential in a sample. In some embodiments, a redox-sensitive dye is sorbed into a membrane at the end of a fiber optic cable. The sorbed dye has optical properties that are sensitive to, and thus provide an indicator of, its redox environment. The dye's optical properties can be queried, for example, by exposing the dye to an appropriate wavelength of light and measuring the dye's absorbance or fluorescence emission at the same or a different appropriate wavelength. In some embodiments, a fiber optic cable is used to expose the dye to light and to measure the dye's absorbance or fluorescence emission. The resulting measurement can be compared with known values for absorbance and fluorescence to determine the redox potential of a sample.

1. Redox Dye Indicators

Embodiments of the present technology provide a redox dye indicator. A redox dye is a chemical that undergoes an observable color change at a specific electrode potential. These color changes can be observed and/or quantified using methods known in the art such as spectrometry to characterize the thermodynamic and kinetic properties of environmental systems. Though a large number of redox indicators have been developed for various applications (see, e.g., Bishop, Indicators, Pergamon: Oxford (1972), p. 746, incorporated by reference in its entirety for all purposes), preferred redox dye indicators are those that quickly and reversibly equilibrate in chemical systems and thus provide a responsive and reversible color change. Several classes of organic redox systems fulfill this characterization. For example, two common types of redox indicators are metal-organic complexes (e.g., phenanthroline) and true organic redox systems (e.g., methylene blue). Almost all redox indicators with true organic redox systems involve a proton as a participant in their electrochemical reaction and consequently display pH-dependent behavior. Examples of redox dye indicators are, e.g., 2,6-dichloro-indophenol, 2,6-dibromophenol-indophenol, ferroin, methyl orange, methyl red, quinoline yellow, methylene blue, resazurin, resorufin, dihydroresorufin, indigo disulfonate, indigo trisulfonate, indigo tetrasulfonate, methyl viologen, 2,2′-bipyridine (Ru complex), 2,2′-bipyridine (Fe complex), nitrophenanthroline (Fe complex), N-phenylanthranilic acid, 1,10-phenanthroline, N-ethoxychrysoidine, 5,6-dimethylphenanthroline (Fe complex), o-dianisidine, sodium diphenylamine sulfonate, diphenylbenzidine, diphenylamine, sodium o-cresol indophenol, neutral red, nile blue, toluylene blue, safranin, thionine (also known as Lauth's violet), and phenosafranine

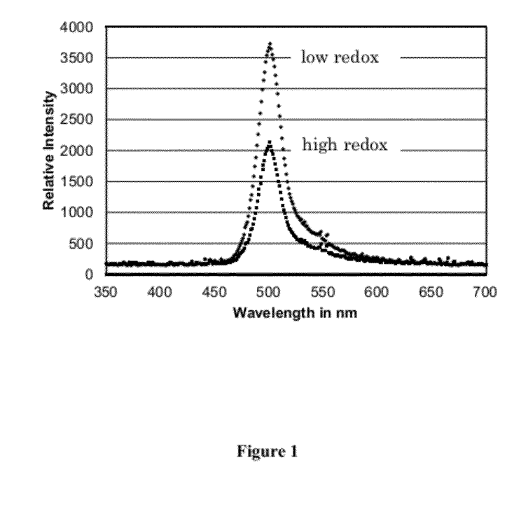

While not limited in the particular chemicals, dyes, or other compositions that can be used as the redox indicator, embodiments of the technology provided herein use the redox indicators phenosafranine and thionine. Phenosafranine and thionine are colored red and blue, respectively, when oxidized and both are colorless (e.g., the “leuco” form) or nearly colorless when reduced. Accordingly, phenosafranine and thionine display high fluorescence emission and high absorbance (low transmittance) at high redox conditions (e.g., in a nitrogen-purged aqueous pH-7 solution) and low fluorescence emission and low absorbance (high transmittance) at low redox conditions (e.g., in an aqueous pH-7 iron(II) solution) (see, e.g., FIG. 1). These indicators can be prepared as salts comprising an appropriate counter ion (e.g., chloride, acetate, etc.). Relevant data for these indicators are presented in the table below.

TABLE 1

| | | | Absorbance | |
|---|---|---|---|---|
| | Chemical | Transition | maximum | |
| Indicator | name | (mV) | (nm) | Structure |
| Phenosafranine | 3,7-diamino-5- phenylphenazinium | −244 | 520 | 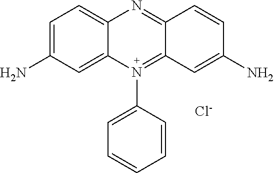 |
| Thionine | 3- (diethylamino)-7- (dimethylamino) phenazathionium | +77 | 598 | 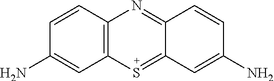 |

Also contemplated are embodiments of the technology using any composition that has an optical characteristic that changes with redox potential and that can be measured after being exposed to an electromagnetic radiation source. In some embodiments, the wavelengths of emission and detection are matched to the particular optical characteristics of the dye.

2. Membranes

Some embodiments provide that the indicator dye is sorbed to a membrane. While not limited in the types of membranes that can be used, in particular embodiments the membrane comprises a perfluorosulfonate anionic film. The membrane can comprise any material that allows the indicator to function as a redox sensor in accordance with the technology. For example, the technology contemplates materials such as synthetic polymers with ionic properties, e.g. the class of polymers called ionomers. Also contemplated are subclasses of ionomers, e.g. sulfonated tetrafluoroethylene-based fluoropolymer-copolymers. In some embodiments, a biocompatible material is used for the membrane.

The process of sorption refers to the action of absorption or adsorption, wherein absorption is the incorporation of a substance in one state into another of a different state (e.g. liquids being absorbed by a solid or gases being absorbed by a liquid) and adsorption is the physical adherence or bonding of ions and molecules onto the surface of another phase (e.g. reagents adsorbed to a solid catalyst surface). Thus, sorption generally includes absorption, adsorption, and ion exchange. Accordingly, the technology provides that the indicator dye is associated with the membrane by any physical process that substantially immobilizes the dye to the membrane while allowing the dye to function adequately as a redox indicator for the purposes of the technology. The indicator dye thus remains associated with the membrane and is not released in any significant amount into the sample being measured with the technology.

3. Light Sources

In some embodiments, the technology provided herein comprises a light source. Any source of light appropriate for transmittal through a fiber optic and for measuring an observable property of the dye (e.g., an optical property, e.g., absorbance or fluorescence emission) can be used. In some embodiments, the light source is an LED or a laser. In some embodiments, the light source produces light of a single wavelength or a narrow band of wavelengths, and in some embodiments, the light source produces light of multiple wavelengths or a spectrum of wavelengths. For example, it is contemplated that embodiments may use an incandescent lamp, a halogen lamp, a fluorescent lamp, a gas discharge lamp, or an arc lamp. Some embodiments provide that the light source provides electromagnetic radiation in pulses and some embodiments provide that the source provides electromagnetic radiation continuously.

4. Fiber Optics

Provided herein are embodiments of the present technology in which electromagnetic radiation (e.g., light) is transmitted by a fiber. While not limited in the means for transmitting light according to the technology, some embodiments use an optical fiber, i.e., a thin, flexible, transparent fiber that acts as a waveguide, or “light pipe”, to transmit light between the two ends of the fiber. Optical fibers are widely used in fiber-optic communications and are thus familiar to those of ordinary skill in the art of fiber optics. Optical fibers are used for illumination and can be provided in bundles to carry images, thus allowing viewing in tight spaces. Specially designed fibers are used for a variety of other applications, including sensors.

While not limited in the construction of the optical fiber, most optical fibers typically comprise a transparent core surrounded by a transparent cladding material with a lower index of refraction. Light is kept in the core by total internal reflection. This causes the fiber to act as a waveguide. Fibers which support many propagation paths or transverse modes are called multi-mode fibers, while those which can only support a single mode are called single-mode fibers. Multi-mode fibers generally have a larger core diameter, and are used for short-distance communication links and for applications where high power is transmitted. Single-mode fibers are used for most communication links longer than about a kilometer.

Fibers have many uses in sensing. In some applications, the sensor is itself an optical fiber. In other cases, fiber is used to connect a non-fiberoptic sensor to a measurement system. Depending on the application, fiber may be used because of its small size or because no electrical power is needed at the remote location.

Optical fibers can be employed to measure many physical characteristics, e.g., light intensity, phase, polarization, wavelength, interference, or transit time of light in the fiber. Sensors that vary the intensity of light (e.g., by changes in absorbance or fluorescence emission at one or more wavelengths) are the simplest, since such measurements can be made using a simple source and detector.

Extrinsic fiber optic sensors use an optical fiber cable, normally a multi-mode one, to transmit modulated light from either a non-fiber optical sensor or an electronic sensor connected to an optical transmitter. A major benefit of extrinsic sensors is their ability to reach samples that may be otherwise inaccessible. For example, to analyze the composition of a sample by spectroscopy, optical fiber bundles are used to transmit light from a spectrometer to a substance which is not placed inside the spectrometer itself. By using fibers, a spectrometer can be used to study objects that are not appropriate for placing inside the spectrometer.

The materials used to construct the optical fiber can be any with the appropriate physical characteristics to allow the propagation of electromagnetic radiation by total internal reflectance along the fiber axis from one end of the fiber to the other. While not limited in the materials that are used, it is contemplated that optical fibers may comprise borosilicate, quartz, UV silica, sapphire, zirconium fluoride, water-free (low-OH) silica, germanium oxide, C1 chalcogenide, C2 chalcogenide, C3 chalcogenide, selenium fiber, plastic, fluorozirconate, fluoroaluminate, or silver halide.

5. Detectors

Embodiments of the technology employ a detector to measure electromagnetic radiation (e.g., light) transmitted from the indicator dye by the optical fiber. The detector can measure the light intensity at one or more wavelengths, and in some embodiments the detector records a continuum of wavelengths (e.g., a spectrum). Thus, it is contemplated that any detector that is appropriate for measuring an intensity of electromagnetic radiation at one or more wavelengths may be used in accordance with the technology. While not limiting the types of detectors that might be used, the types of detectors contemplated comprise a photoresister, a photovoltaic cell, a photodiode, a photomultiplier tube, a photocathode, a phototransister, a charge-coupled device, or a reverse-biased LED.

In some embodiments, the detector is a photodetector, e.g. a spectrometer, which analyzes substances by bouncing light off and through them. In some embodiments, some of the light is absorbed and a lesser intensity of light is reflected at the same wavelength. In some embodiments, the light is absorbed and the energy is subsequently emitted at a longer wavelength (e.g., fluorescence). In particular, a spectrometer (also known as a spectrophotometer, spectrograph, or spectroscope) is an instrument used to measure properties of light over a specific portion of the electromagnetic spectrum, typically used in spectroscopic analysis to identify materials. Light intensity is most often the variable measured but it could also be, for instance, polarization state. The independent variable is usually the wavelength of the light or a unit directly proportional to the photon energy, such as wavenumber or electron volts, which has a reciprocal relationship to wavelength. A spectrometer can be used in spectroscopy for producing spectral lines and measuring their wavelengths and intensities. Spectrometer is a term that is applied to instruments that operate over a very wide range of wavelengths, from gamma rays and X-rays into the far infrared. If the region of interest is restricted to within or near the visible spectrum, the study is sometimes called spectrophotometry. In general, any particular instrument might operate over a small portion of this total range because of the different techniques used to measure different portions of the spectrum. Below optical frequencies (i.e., at microwave and radio frequencies), the spectrum analyzer is a closely related electronic device.

6. Methods of Use

Embodiments of the technology provide methods for measuring redox potential. In some embodiments, measuring redox potential comprises using a fiber optic redox sensor comprising a redox dye sorbed to a membrane. For example, contacting a sample to the membrane causes changes in the optical properties of the redox dye. When exposed to a source of electromagnetic radiation optically coupled to the membrane, changes in the dye's optical properties are measured by a detector optically coupled to the membrane. In some embodiments, optical fibers are used for optically coupling components. By placing the membrane in contact with a sample the technology is used to measure redox potential of the sample. A reading provided by the detector is compared with standard values to provide a redox potential measurement for the sample. The sample is tested either after removing the sample from its natural milieu and environment or without removing the sample from its natural milieu and environment. When the sample is tested in its natural milieu, the methods provide a method to obtain an in situ measurement of redox potential.

Accordingly, embodiments of the methods find use in environmental settings. For example, redox potential is useful in describing, predicting, monitoring, and modeling chemical speciation, chemical reactions, microbial degradation, and contaminant plume migration in environmental samples. To obtain a redox potential measurement according to embodiments of the methods provided herein, the membrane is placed in contact with an environmental sample, a reading is generated by the detector, and the reading is compared with standard values to produce a redox potential of the sample. Such measurements are important in characterizing, e.g., fresh waters, including surface and ground waters, as well as estuarine and sea waters. The methods also find use in determining the redox potentials at various locations, for particular layers, or for particular organisms within a microbial mat or soil sample. Specific embodiments of the methods provided can be used to measure redox potential for bioremediation, e.g. the bioremediation of soil or water. For example, the methods find use to study the operational lifetime of zero-valent iron remediation procedures or the in-situ microbial reduction of chlorinated low molecular weight hydrocarbons.

Moreover, embodiments of the methods provided herein find use in clinical settings. For example, by contacting the membrane to a tissue or a cell sample, the redox state of the tissue or cell sample can be determined. In some embodiments, the measurement of redox potential is made on a subject in vivo. In such an in-vivo measurement, the sample is in, on, or otherwise remains in its natural milieu associated with the subject. In some embodiments, the sample is removed from the subject prior to measuring redox potential (i.e., “ex vivo”).

In some embodiments, the methods provided find use in a research setting. For example, the methods provide that redox potential is measured for cells or tissues in cell or tissue culture.

To obtain a redox potential measurement for cells or tissues in culture, the membrane is placed in contact with the culture, a reading is generated by the detector, and the reading is compared with standard values to produce a redox potential measurement of the culture. Also, the methods find use in monitoring the redox state of solutions, cultures, materials, compositions, etc. used in a research laboratory, e.g., bacterial cultures, eukaryotic cell cultures (e.g. a yeast culture), archaeal cultures, fermenters, biofilms, soils, plant tissues, chemical reactions, bioreactors, fuel cells, electrochemical cells (e.g., a battery), etc. For example, the methods find use in a research setting to monitor the redox state in laboratory models of bioremediation, e.g., in a model bioremediation column.

7. Data Collection, Storage, and Analysis

Some embodiments of the technology provided herein further comprise functionalities for collecting, storing, and/or analyzing data (e.g., a redox measurement). For example, in some embodiments the device comprises a processor, a memory, and/or a database for, e.g., analyzing data, performing calculations using the data, transforming the data, and storing the data. Moreover, in some embodiments a processor is configured to control the device, e.g., the processor is used to select a wavelength to transmit to the membrane and/or to select the wavelength to observe with the detector. In some embodiments, the processor is used to initiate and/or terminate the measurement and data collection. In some embodiments, the device comprises a user interface (e.g., a keyboard, buttons, dials, switches, and the like) for receiving user input that is used by the processor to direct a redox potential measurement. In some embodiments, the device further comprises a data output for transmitting data to an external destination, e.g., a computer, a display, a network, and/or an external storage medium. Some embodiments provide that the device is a small, handheld, portable device incorporating these features and components.

### EXAMPLES

### Example 1

During the development of embodiments of the present technology, the absorbance characteristics of phenosafranin were measured as a function of redox state. In this measurement, the light detected by the detector is high when the absorbance is low and the light detected by the detector is low when the absorbance is high. As shown in FIG. 1, at low redox state, the light detected at ˜500 nanometers is higher relative to the light detected at a high redox state.

### Example 2

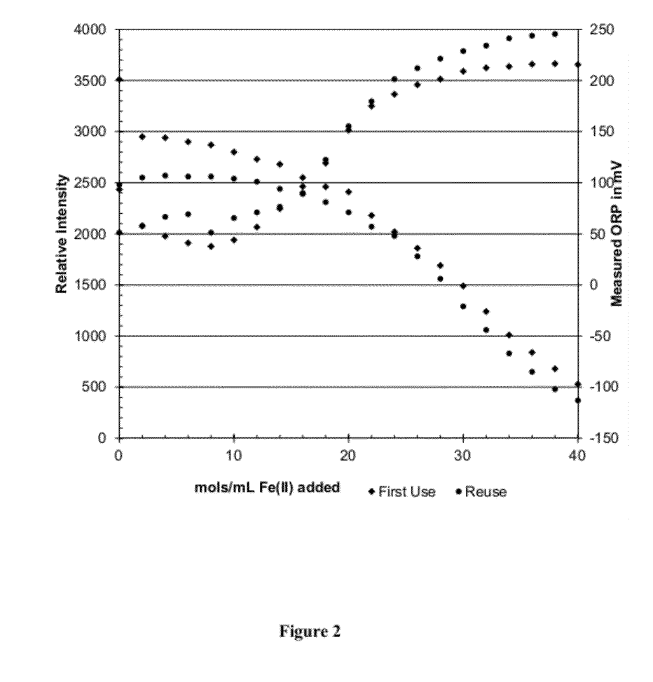

During the development of embodiments of the technology provided herein, it was demonstrated that dye absorbance reproducibly tracks the measured oxidation-reduction potential in a sample. The intensity of light transmitted by the dye was measured as a function of Fe(II) concentration. As shown in FIG. 2, the relative intensity of light detected was low (˜2000 relative intensity units) and increased to ˜3500-4000 relative intensity units with increasing Fe(II) concentration (measured in moles per milliliter). As the Fe(II) concentration was varied and the light intensity was adjusted, simultaneous measurements of the sample's oxidation-reduction potential began at a high value (˜150-100 millivolts) and decreased with addition of Fe(II) to ˜−100 millivolts. After a first Fe(II) titration, the behavior of the dye was reproducible during a subsequent titration.

### Example 3

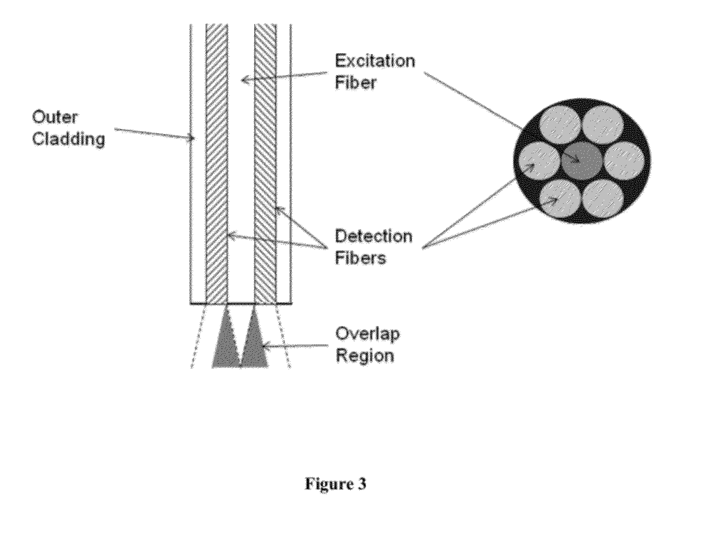

In accordance with the development of embodiments of the technology provided herein, various arrangements of excitation and detection fibers are contemplated. FIG. 3 shows two views of one embodiment of the technology wherein an excitation fiber is surrounded by detection fibers and the entire fiber bundle is surrounded by an outer cladding. Also shown is an overlap region where the detection fiber receives and transmits light reflected or emitted from the sample upon exposure by the excitation light.

### Example 4

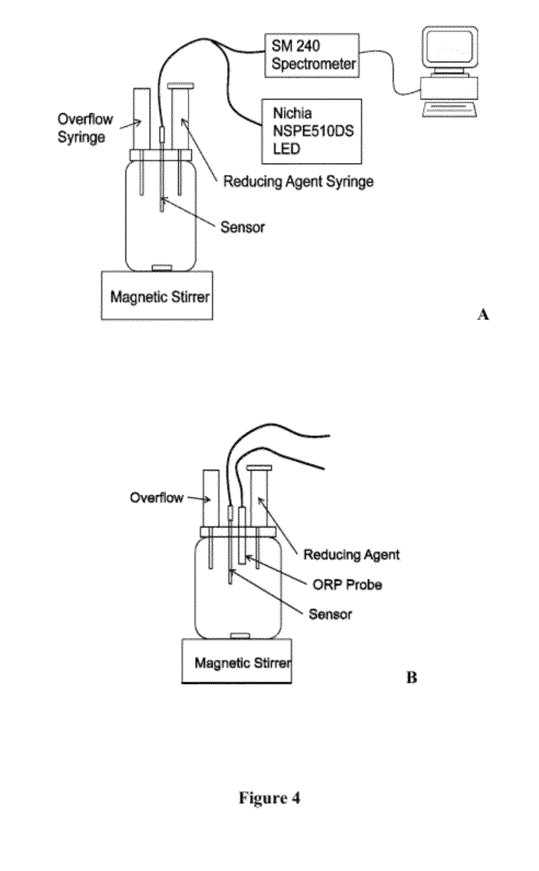

In accordance with the development of embodiments of the technology provided herein, various exemplary implementations of the technology are contemplated. FIG. 4 shows examples of bench-scale measurement apparatuses using the technology provided herein. In an embodiment shown in FIG. 4A, the sensor is incorporated into a sample chamber and interfaced to a spectrometer. An LED is used for excitation and a computer records data measured by the spectrometer. In another embodiment shown in FIG. 4B, the sensor chamber can be modified to incorporate a commercial oxidation-reduction probe for calibration and comparison experiments.

All publications and patents mentioned in the above specification are herein incorporated by reference in their entirety for all purposes. Various modifications and variations of the described devices, methods, systems, kits, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in engineering, spectroscopy, biochemistry, medical science, or related fields are intended to be within the scope of the following claims.

We claim:

1. A device for sensing redox potential comprising:
a) an electromagnetic radiation source;
b) a membrane optically coupled to the electromagnetic radiation source; and
c) a dye sorbed to the membrane.

2. The device of claim 1, further comprising a detector optically coupled to the membrane.

3. The device of claim 2, further comprising an excitation fiber and a detection fiber, wherein the excitation fiber optically couples the membrane to the electromagnetic radiation source and the detection fiber optically couples the membrane to the detector.

4. The device of claim 1, wherein the electromagnetic radiation source is selected from the group consisting of a light emitting diode (LED), a laser, an incandescent lamp, a halogen lamp, a fluorescent lamp, a gas discharge lamp, and an arc lamp.

5. The device of claim 1, wherein the electromagnetic radiation source produces light of about 520 nanometers or about 598 nanometers.

6. The device of claim 1, wherein the dye has an observable property that changes with the redox state of the dye.

7. The device of claim 1, wherein the dye is a photoactive dye.

8. The device of claim 10, wherein the photoactive dye is selected from the group consisting of 3,7-diamino-5-phenylphenazinium and 3-(diethylamino)-7-(dimethylamino)phenazathionium.

9. The device of claim 2, wherein the detector monitors light intensity at a wavelength selected from the group consisting of a wavelength that is about the same wavelength as the wavelength produced by the electromagnetic radiation source, a wavelength that is longer than the wavelength produced by the electromagnetic radiation source and a wavelength that is about 100 nanometers longer than the wavelength produced by the electromagnetic radiation source.

10. The device of claim 2, wherein the detector is a photoresister, a photovoltaic cell, a photodiode, a photomultiplier tube, a photocathode, a phototransister, a charge-coupled device, or a reverse-biased LED.

11. The device of claim 3, wherein the excitation fiber is made of borosilicate, quartz, UV silica, sapphire, zirconium fluoride, water-free (low-OH) silica, germanium oxide, C1 chalcogenide, C2 chalcogenide, C3 chalcogenide, selenium fiber, plastic, fluorozirconate, fluoroaluminate, or silver halide.

12. The device of claim 3, wherein the detection fiber is made of borosilicate, quartz, UV silica, sapphire, zirconium fluoride, water-free (low-OH) silica, germanium oxide, C1 chalcogenide, C2 chalcogenide, C3 chalcogenide, selenium fiber, or silver halide.

13. A method for measuring redox potential of a sample comprising:
a) contacting the sample with the device of claim 2;
b) obtaining a light intensity reading; and
c) comparing the light intensity reading with an expected value corresponding to a high or a low redox potential to generate a redox potential measurement.

14. The method of claim 13, wherein the light intensity reading has a high value when the sample has a high redox potential and a low value when the sample has a low redox potential.

15. The method of claim 13, wherein the light intensity reading has a low value when the sample has a high redox potential and a high value when the sample has a low redox potential.

16. The method of claim 14, wherein a transition between the low and high values occurs at a redox potential of about −244 millivolts or about 77 millivolts.

17. The method of claim 13, wherein the sample is a water sample and the redox potential measurement provides a measure of a water quality of the sample.

18. The method of claim 13, wherein the sample is a biological sample and the redox potential measurement provides a measure of the redox state of the biological sample.

19. The method of claim 13, wherein the sample is a clinical sample and the redox potential measurement provides a measure of the redox state of the clinical sample.

20. A kit for measuring redox potential comprising:
a) a device according to claim 1;
b) printed matter comprising a reference value for a redox potential measurement;
c) an instruction for use of the device.

21. The kit of claim 20 further comprising a composition for use as a reference standard.

22. A system for measuring redox potential comprising:
a) a device according to claim 1; and
b) a redox potential reference value;

23. The system of claim 22 further comprising a composition for use as a reference standard.
